(19) United States
(12) Patent Application Publication
(10) Pub. No.: US 2007/0013902 A1
(43) Pub. Date: Jan. 18, 2007

(54) Apparatus for Inspecting a Wafer

(75) Inventors: Henning Backhauss, Wetzlar (DE); Albert Kreh, Solms (DE); Christof Krampe-Zadler, Castrop-Rauxel (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Wetzlar (DE)

(21) Appl. No.: 11/422,182

(22) Filed: Jun. 5, 2006

(30) Foreign Application Priority Data
Jul. 15, 2005 (DE) 10 2005 033 036.3

(51) Int. Cl. G01N 21/88

(52) U.S. Cl. 356/237.5

(57) ABSTRACT

The present invention relates to an apparatus and method for automatically inspecting a wafer, having a light source and an illumination optics for illuminating the wafer for inspection, wherein the illumination optics comprises a variable gray filter for adjusting the illumination power.

### RELATED APPLICATIONS

This application claims priority to German application serial number DE 10 2005 033 036.3 on Jul. 15, 2005, which is incorporated herein by reference in its entirety.

### FIELD OF THE INVENTION

The present invention relates to an apparatus for illuminating a wafer in the context of an inspection apparatus for inspecting a wafer. The present invention also relates to a method of adjusting the illumination power in the context of inspecting a wafer.

### BACKGROUND OF THE INVENTION

Apparatus and methods of the above type are well known. With these apparatus and methods the wafer is illuminated by an illumination means with a light source and an illumination optics within an inspection apparatus so that a measuring signal or an image of the wafer is recorded by a detection means for further processing.

Devices of the above type are used in the industry in the context of computer chip manufacture as automatic macro defect detection and classification systems. The Leica LDS 3300 M system is a typical example. This system is sold as a complete, integral system in the industry. In operation the continuous uniform quality of inspection and defect control is required. The systems are run with essentially the same software and particularly with essentially the same recipes for every wafer design of the same type. The same wafer design type refers to a wafer with the same chip design and a comparable stage in the progress of production. The same type of wafer design is therefore inspected by inspection systems under the same preconditions. This also applies to a plurality of separately installed systems of the same type. “Recipes” refer to the predetermined adjustments which adapt the measuring software to the different types of wafer layout and production stages.

It has been found that in particular a uniform illumination is important to achieve reproducible inspection. The flash lamps usually employed for illumination, however, have considerable differences in their light power even in their newly manufactured state. Also, during the lifetime of a flash lamp, the power of the flash lamp may decrease dramatically. Each of the two effects can lead to a decrease in the light power by a factor of 2. The light power of the flash lamps can be controlled electronically, for example, by means of their capacitors. This range of control is needed, however, at least partially for varying the illumination power in the context of the inspection provided. The differences in maximum illumination power of the flash lamps therefore limit their useful dynamic range for adjusting the illumination power in the context of inspection measurements by the electronic drive of the flash lamp.

### SUMMARY OF THE INVENTION

It is therefore an object of the present invention to further develop an apparatus and a method of the initially mentioned type in such a way that the electronically controllable variable range of the illumination means is maintained for a plurality of systems of the same type and over time.

This object is achieved by the apparatus as defined in claim 1 and by the method as defined in claim 17. Advantageous embodiments of the invention are defined in the dependent claims.

The object is achieved according to the present invention in an apparatus for inspecting a wafer with a light source and an illumination optics for illuminating the wafer for inspection by having the illumination optics comprise a variable gray filter for adjusting the illumination power. With the aid of the variable gray filter, light sources having higher illumination power can be adapted to the level of light sources used with lower illumination power. This is suitably arranged with respect to the weakest light source tolerated and its maximum tolerated ageing.

Preferably it is provided that the gray filter is arranged between the flash lamp and its reflector on the one hand and the illumination optics on the other, wherein the illumination optics can comprise in particular one or more optical fibers. Such an arrangement facilitates a particularly compact construction.

Suitably it is provided that the light source and the gray filter are arranged on a common carrier. This is advantageous in that the gray filter and the flash lamp have a defined arrangement, in particular a defined distance, and therefore a defined optical effect.

Advantageously the light source and the gray filter are arranged in a common housing. This is advantageous in that the light source and the adjusted gray filter, in their common housing in the inspection system, appear as a standardized overall light source. Also, standardizing of the light source in the housing is also possible outside of the inspection system.

Advantageously it is provided that the transmission of the gray filter is infinitely variable. This enables the light power of the light source to be optimally adapted to the required standard.

Advantageously the gray filter is formed as a rotatable filter wheel. This enables a particularly space-saving arrangement and particularly simple driving of the adjustment.

The gray filter can be continuously formed as a gray scale wedge or can have tones or graduations having a smaller distance than the aperture on the gray filter. The gray filter can also be formed as a slit or screen aperture, wherein a plurality of slits or holes are always covered by the aperture. The filter can also be infinitely varied by each of the thus defined apertures.

It is provided particularly advantageously that the transmission of the gray filter is automatically adjustable. The standard maximum illumination power of the light source can thus be established or recovered at given intervals without user intervention.

It is preferably provided that the gray filter has a transmission range in the order of 10% to about 100%, in particular between 5% and about 100%.

It is provided particularly advantageously that the gray filter has a transmission range in the order of 1% to about 100%. The transmission ranges cited have the advantage that intensity fluctuations of the maximum illumination power due to different flash lamps and due to the ageing process of the flash lamps can be compensated.

Advantageously it is provided that the gray filter is also a UV blocking filter. The blocking effect can be achieved by suitably selecting the carrier glass or by an additional coating of the filter glass.

Ideally it is provided that the gray filter is combined with a color conversion filter. The color conversion filtering effect can be achieved by an additional coating of the gray filter. This coating can be applied, for example, on the opposite side of the gray coating. This also applies to the UV blocking filter. By additionally taking over the UV blocking effect and/or the color conversion filtering effect, the gray filter is of additional use and an additional one or two components can be saved.

According to one embodiment, the light source itself has a means for power adjustment, which can be electronic, for example.

According to another embodiment, the light source is a flash lamp.

According to a preferred embodiment, the flash lamp comprises a variably chargeable flash capacitor.

According to the present invention the above mentioned object is achieved by using a method of adjusting the illumination power for similar inspection systems with the same recipes for inspecting a wafer by the following steps:
optically attenuating the illumination power in the inspection system with a variable filter in the illumination beam path to a predefined power level at a predefined percentage of lamp power,
measuring the power of the illumination at a predefined percentage of lamp power,
readjusting the optical attenuation after measuring, to the predefined power level at the predefined percentage of lamp power.

“Recipes” refer to the predetermined adjustments for adapting the measuring software to the various wafer layout types and production stages of the wafers. A “defined percentage of the lamp power” means that the lamp power is brought to a predefined percentage value of the maximum lamp power, such as the maximum lamp power value of 100%, by means of electronic control. The “predefined power level” refers to the level of the illumination power of the weakest flash lamp still acceptable for the wafer inspection system minus its power loss expected due to the ageing process. Measuring the power also corresponds to measuring the intensity so that referring to the power, of course, also comprises a consideration of the intensity.

By using the electronically controllable device for power adjustment, independent of the variable gray filter, the illumination power can be freely controlled by the software program for operating the wafer inspection system at the maximum illumination power as standardized by the variable gray filter.

Preferably it is provided that the step of optically attenuating with a variable gray filter in the illumination beam path is downstream of the light source. The variable gray filter can be a gray scale wedge or a filter disk.

Suitably, the steps of measuring and readjusting are carried out at predefined intervals. This is to ensure uniform quality of the illumination. The intervals can be as a function of wafer throughput or service life.

According to one embodiment, measuring and readjustment is carried out in daily intervals. Intervals of several hours or of a plurality of days or a plurality of weeks are also conceivable.

According to a preferred embodiment of the invention, measuring and readjusting are carried out automatically.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The present invention will be explained in more detail in the following with reference to schematic representations of a preferred embodiment. The same reference numerals refer to the same elements throughout the individual figures, in which:

FIG. 1 is a sectional view of a flash lamp according to the present invention, together with its filter and housing,

FIG. 2 is a schematic representation of an illumination optics in a wafer inspection system,

FIG. 3 is a second schematic representation of the illumination optics in a wafer inspection system, and

FIG. 4 is a third schematic representation of the illumination optics in a wafer inspection system.

### DETAILED DESCRIPTION OF THE PREFERRED EMBODIMENTS

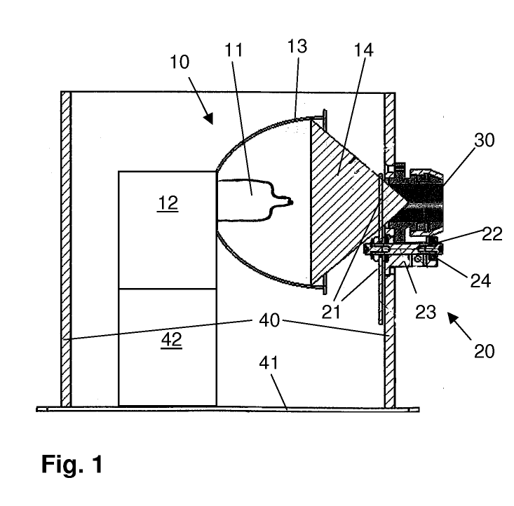

FIG. 1 shows flash lamp 10 with flash bulb 11 as a light source, mount 12 and reflector 13. The power supply for the flash bulb through its mount comprises an electric inductor 42 allowing the flash power of the flash lamp to be controlled. For example, the flash lamp has a normal maximum power of 50 mJ. The electric inductor is for adjusting the flash bulb power in the range from 100% to 10% of the maximum flash power, in this case between 50 mJ and 5 mJ. The variance of the maximum flash power tolerated for the flash lamp is in the range from 50 mJ to about 125 mJ for the various flash bulbs, which is a factor of 2.5 for the range of fluctuation. Due to its reflector the flash bulb projects an aperture cone 14. Filter disk 21 of filtering means 20 is introduced in the aperture cone. The filter disk has a rotary axle 22 supported in a rotary bearing 23. Rotary axle 22 ends in a coupling 24 via which the position of the filter disk can be rotated. The rotation can be carried out either manually or automatically via a drive flanged to the axle. Aperture cone 14 passes through the filter disk in the area of optical fiber mount 30. In the introduced optical fiber cable (not shown) aperture cone 14 is coupled into the optical fiber cable. Flash bulb 10 and filtering means 20 are surrounded by a common housing 40 and mounted on a common carrier 41. The housing also comprises electric inductor 42.

Due to ageing the flash power can decrease by a factor of 2, i.e. by 50%, in the present example from 50 mJ to 25 mJ. There is thus a tolerance range for the flash power from a minimum of 25 mJ to a maximum of 125 mJ in the present example. In order to compensate this tolerance range by means of the electric inductor of the flash bulb, a very large portion of the dynamic range of the inductor would be lost just for the adjustment. In the context of wafer inspection, however, a very high dynamic range is required for varying the flash lamp power. Sometimes the full variation range of the electric inductor is necessary for executing the software controlled measuring programs. Due to the adjustment of the filter disk to a predefined power level, here 25 mJ, every flash lamp tolerated and every ageing stage can be used in our example and supplies the same maximum power of 25 mJ. Thus for every tolerated flash lamp the whole dynamic range of the electric inductor can be used for varying the lamp power to carry out the measuring programs.

FIG. 2 shows a flash bulb 10 with a rotatable filter disk 21 within a wafer inspection system 70. The wafer inspection system comprises, among others, a camera 60, a beam splitting mirror 61, a luminous field 62, an optical fiber 31 and the wafer 50 to be inspected. Optical fiber 31 conducts the light passing from the flash bulb of the flash lamp through filter disk 21 onto luminous field 62. The thus diffusely diffracted light passes via the beam splitting mirror onto the surface of wafer 50 and illuminates the latter for imaging by camera 60. The beam splitting mirror, the luminous field and the camera are arranged so that the light of luminous field 62 has its central beam impinge vertically onto the surface of the wafer in the same way as the central beam of the camera so that a bright field image results.

FIG. 3 shows a wafer inspection system with an arrangement similar to the one in FIG. 2. Rotary filter disk 21 is not, however, arranged in the housing of flash lamp 10, but between the end of optical fiber 32 facing away from the flash lamp and a lens optics for vertical illumination of the wafer. A beam splitting mirror 61 is, again, arranged in such a way that a camera image is vertically taken of the surface of the wafer also in a bright field image.

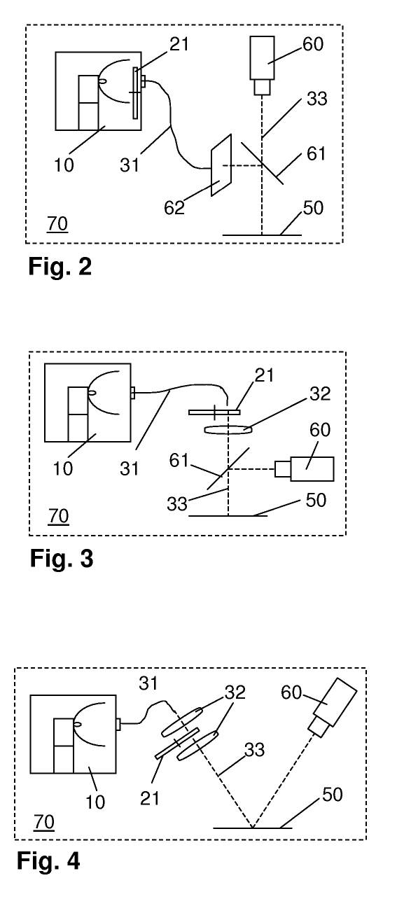

FIG. 4 shows a wafer inspection system with a further arrangement similar to the one of FIG. 2. Herein the rotary filter disk 21 is arranged within a lens optics 32. Again, the illumination and detection is designed for bright field imaging, wherein the central illumination beams and imaging beams do not, however, impinge vertically on the surface of the wafer as in FIGS. 2 and 3, but at the same, mirrored, angle.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for automatically inspecting a wafer, comprising a light source for illuminating the wafer for inspection, an illumination optics arranged in front of the light source and a variable gray filter for adjusting the illumination power of the light source is provided in front of the light source.

2. The apparatus according to claim 1, wherein the light source is flash lamp and the gray filter is arranged between the flash lamp and a reflector of the flash lamp on the one hand and the illumination optics on the other, wherein the illumination optics comprises one or more optical fibers.

3. The apparatus according to claim 1, wherein the gray filter is arranged between the illumination optics and the wafer, wherein the illumination optics comprises one or two optical fibers.

4. The apparatus according to claim 1, wherein the light source and the gray filter are arranged on a carrier.

5. The apparatus according to claim 1, wherein the light source and the gray filter are arranged in a housing.

6. The apparatus according to claim 1, wherein the gray filter has a transmission which is infinitely variable.

7. The apparatus according to claim 1, wherein the gray filter is configured as a rotary filter disk.

8. The apparatus according to claim 1, wherein the gray filter has filter graduations of different transmission and the gray filter has an aperture which covers at least two filter graduations.

9. The apparatus according to claim 1, wherein the gray filter has a transmission which is automatically variable.

10. The apparatus according to claim 1, wherein the gray filter has a transmission range in the order of 10% to about 100%.

11. The apparatus according to claim 1, wherein the gray filter has a transmission range in the order of 1% to about 100%.

12. The apparatus according to claim 1, wherein the gray filter is also a UV blocking filter.

13. The apparatus according to claim 1, wherein the gray filter is combined with a color conversion filter.

14. The apparatus according to claim 1, wherein the light source itself is equipped with a means for changing the illumination intensity.

15. A method of adjusting the illumination power for inspection systems of the same type carrying out the same recipes for inspecting a wafer, comprising the steps of:
optically attenuating the illumination power in the inspection system with a variable filter in an illumination beam path of a light source to a predefined power level at a predefined percentage of a power of the light source,
measuring the power of the illumination at a predefined percentage of the power of the light source,
readjusting the optical attenuation after measuring the predefined power level at the predefined percentage of the power the light source.

16. The method according to claim 15, wherein the step of optically attenuating is carried out with a variable gray filter in the illumination beam path downstream of the light source.

17. The method according to claim 15, wherein the steps of measuring and readjusting are carried out at predefined intervals.

18. The method according to claim 17, wherein the predefined intervals are one day.

19. The method according to claim 15, wherein the light source is a flash lamp.

20. The method according to claim 19, wherein the predefined power level is the level of the illumination power of the weakest flash lamp acceptable for the wafer inspection system minus its expected power loss due to ageing.

21. The method according to claim 15, wherein the predefined percentage of the power of the light source is 100% of the maximum power of the light source.

22. The method according to claim 15, wherein the steps of measuring and readjusting are carried out automatically.
